(19) United States
(12) Patent Application Publication
(10) Pub. No.: US 2023/0368689 A1
(43) Pub. Date: Nov. 16, 2023

(54) Informed Learning Management System

(71) Applicant: Maxwell Stribling, Maplewood, NJ (US)

(72) Inventor: Maxwell Stribling, Maplewood, NJ (US)

(21) Appl. No.: 17/740,355

(22) Filed: May 10, 2022

(51) Int. Cl. G09B 5/06

(52) U.S. Cl. CPC G09B 5/065

(57) ABSTRACT

This Learning Management System website, web app and application, that will help academic and private sector/corporations increase students/employees/the end-user's retention rates of material/data by easing the consumption of said information by restructuring the data/material I to smaller, more easily digestible bits/packages for consumption. The restructured data will be accessed by the end user via two means of distribution: 1) the bits are pushed to devices, based on a frequencies effecting space repetition, and 2) the bits will be streamed via audio/video stream-like a radio station. This is an asset for those who have difficulty reading and studying, by removing the barrier of effort required to start and fatigue that might result from reading.

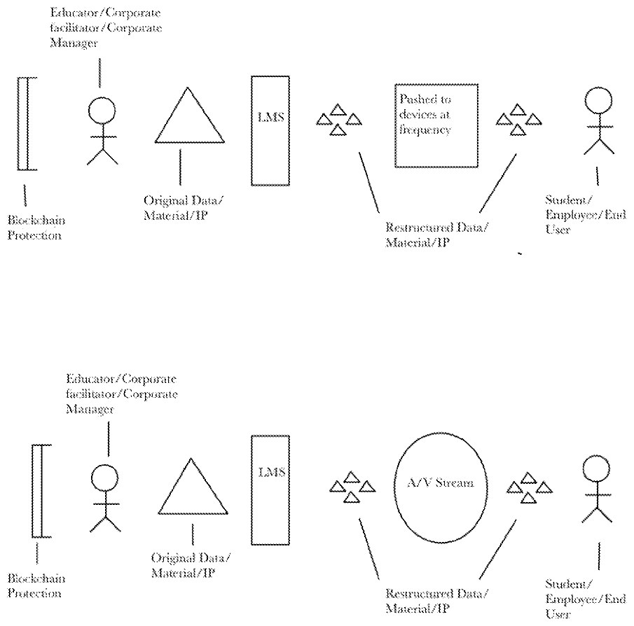

### BRIEF SUMMARY OF THE INVENTION

A Learning Management System (LMS), comprised of a website, web app and mobile applications, to ease data retention and application for organization, via spaced repetition. Organizations or corporation can upload material for consumption to website and/or application LMS interface. The LMS “digests” or breaks down the material into smaller bits (size can be adjusted/customized as needed) for consumption by end-users, and is distributed to end-users via two channels: Material is pushed to devices at specific frequencies, to effect spaced repetition; and audio/video streaming channel, like radio and livestreams. Material is secured via blockchain.

### BRIEF DESCRIPTION OF THE DRAWINGS

Shows how organization uploads material to LMS; how LMS restructures material, and how LMS distributes/makes accessible material via two channels for end-users to consume material.

### DETAILED DESCRIPTION OF THE INVENTION

The product is a Learning Management System (LMS), comprised of a website, web app and mobile applications, for data consumption purposes, for academic institutions, corporations/the private sector and homeschooling. The system will allow educators/corporate facilitators (i.e corporate trainers, management and heads of departments) to upload information to LMS, to have material/data broken down into smaller, easier digestible parts for consumption, and have the restructured data pushed to devices at specific frequencies to the end-user based on the learning technique of spaced repetition. The goal is to ease learning and retention of material/data via passive consumption of information.

Additionally, the LMS will have a streaming feature which will operate 24 hours per day and seven days per week. This operation will be like the 24 hours per day and seven days per week of radio stations. The end-user will be able to access the smaller bits of restructured material/data via both audio and visual information. The end-user will be able to select/navigate to a specific part of a stream, or simply tune into what is currently streaming.

The proprietor and educator information will be secured via blockchain which will prevent users outside of the educational institution or firm from accessing material on the LMS.

(Organization will be interchangeable for academic and corporate or private sector settings, companies, enterprise, institutions. Facilitator is interchangeable with teacher, trainer, manager and all other manner of entities wanting to furnish material to be learned, retained and/or applied. End-user refers to all recipients of said material, who desire to retain, remember, learn or apply furnished material. Material is interchangeable with all forms of data, intellectual property [IP], knowledge and information.)

1. A Learning Management System designed for both academic/educational and corporate use, securing IP/proprietor information via blockchain A Learning Management System using a distribution channel of 24/7 audio/video streaming of material A Learning Management System using a distribution channel where material is pushed at adjustable frequencies to students/employees/team members/end-users. A Learning Management System focused on spaced repetition. A Learning Management System that breaks down/restructures material/information into smaller bits/packages for easier consumption by students/employees/the end-user.
